(19) United States
(12) Patent Application Publication
(10) Pub. No.: US 2026/0352836 A1
(43) Pub. Date: Nov. 5, 2026

(54) RESTORE MESH CONNECTIVITY AND ATTRIBUTES AFTER CONNECTIVITY REGULARIZATION

(71) Applicant: TENCENT AMERICA LLC, Palo Alto, CA (US)

(72) Inventors: Chao HUANG, Palo Alto, CA (US); Pranav Kadam, Palo Alto, CA (US); Shan Liu, Palo Alto, CA (US)

(73) Assignee: TENCENT AMERICA LLC, Palo Alto, CA (US)

(21) Appl. No.: 19/365,416

(22) Filed: Oct. 22, 2025

Related U.S. Application Data
(60) Provisional application No. 63/800,386, filed on May 5, 2025.

(51) Int. Cl. H04N 19/14; H04N 19/463

(52) U.S. Cl. CPC H04N 19/14; H04N 19/463

(57) ABSTRACT

A method performed by at least one processor in a decoder including receiving a bitstream comprising an encoded mesh, a first parameter indicating a connectivity regularization (CR) type, and a second parameter associated with restoration of an edge of at least one face in the encoded mesh; determining the first parameter indicates the CR type removes edges from the mesh; and reconstructing the at least one face of the encoded mesh using the second parameter.

### CROSS-REFERENCE TO RELATED APPLICATION

This application claims priority from U.S. Provisional Application No. 63/800,386 filed on May 5, 2025, the disclosure of which is incorporated herein by reference in their entirety.

### FIELD

This disclosure is directed to a set of advanced video coding technologies. More specifically, the present disclosure is directed to restore mesh connectivity and attributes after connectivity regularization.

### BACKGROUND

A polygon mesh usually consists of several connected components (CCs), which may have different characteristics, so it's beneficial to divide CCs into different groups of CCs (named slices in this disclosure) based on their characteristics such that they can be compressed adaptively and efficiently. While connectivity regularization is commonly used to improve the efficiency of coding polygon meshes, and to recover the original connectivity and attributes, the inverse operation of connectivity regularization needs to be carried out.

### SUMMARY

According to an aspect of the disclosure, a method performed by at least one processor in a decoder includes: receiving a bitstream comprising an encoded mesh, a first parameter indicating a connectivity regularization (CR) type, and a second parameter associated with restoration of an edge of at least one face in the encoded mesh; determining the first parameter indicates the CR type removes edges from the mesh; and reconstructing the at least one face of the encoded mesh using the second parameter.

According to an aspect of the disclosure, a method performed by at least one encoder includes receiving a mesh comprising a plurality of vertices; encoding the mesh in accordance with a connectivity regularization (CR) type that removes edges from the mesh; encoding a first parameter indicating the CR type; encoding a second parameter associated with restoration of an edge of at least one face in the mesh; and generating a bitstream comprising the mesh, the first parameter, and the second parameter.

According to an aspect of the disclosure, a non-transitory computer readable medium storing a bitstream that is generated by an encoding method, the encoding method includes: receiving a mesh comprising a plurality of vertices; encoding the mesh in accordance with a connectivity regularization (CR) type that removes edges from the mesh; encoding a first parameter indicating the CR type; encoding a second parameter associated with restoration of an edge of at least one face in the mesh; generating the bitstream comprising the mesh, the first parameter, and the second parameter.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4 illustrates an example of triangulation in a mesh, in accordance with embodiments of the present disclosure.

FIG. 5 illustrates an example of edge flipping in a mesh, in accordance with embodiments of the present disclosure.

FIG. 6 illustrates an example of edge removal in a mesh, in accordance with embodiments of the present disclosure.

FIG. 7 illustrates an example process of signaling a direction of removed diagonal edges, in accordance with embodiments of the present disclosure.

FIG. 8 illustrates an example process of signaling directions of removed diagonal edges for non-initial faces of connected components (CCs) in dual-degree geometry coding, in accordance with embodiments of the present disclosure.

FIG. 9 illustrates an example decoding process, in accordance with embodiments of the present disclosure.

FIG. 10 illustrates an example process for choosing a context of coding a removed diagonal edge, in accordance with embodiments of the present disclosure.

FIGS. 11-13 illustrate lossless results of fixed type 1 connectivity regularization vs. TM v9.0 with default configurations (cfgs), in accordance with embodiments of the present disclosure.

FIGS. 14-16 illustrate lossless results of fixed type 1 CR vs. TM v9.0 with per mesh cfgs, in accordance with embodiments of the present disclosure.

FIGS. 17-19 illustrate lossless results of type 2 CR vs fixed type 1 CR with default cfgs, in accordance with embodiments of the present disclosure.

FIGS. 20-22 illustrate lossless results of type 2 CR vs. fixed type 1 CR with per mesh cfgs, in accordance with embodiments of the present disclosure.

FIG. 23 illustrates an example computer system, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

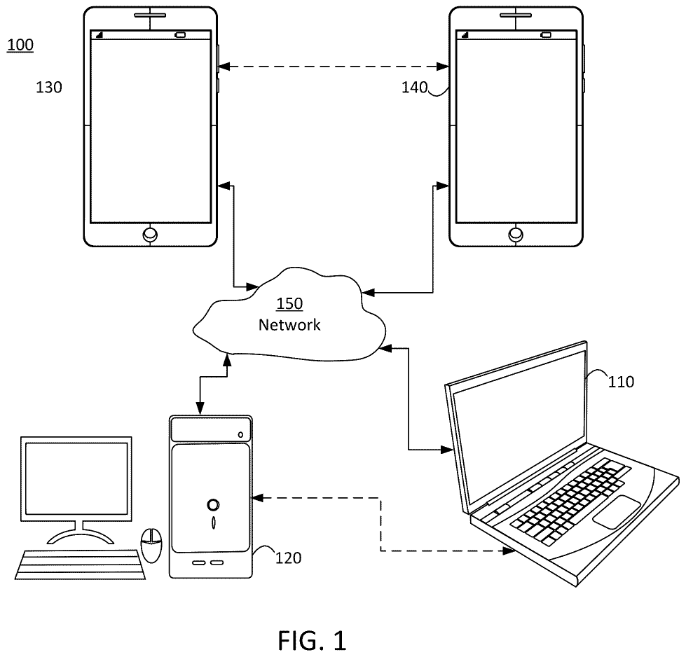

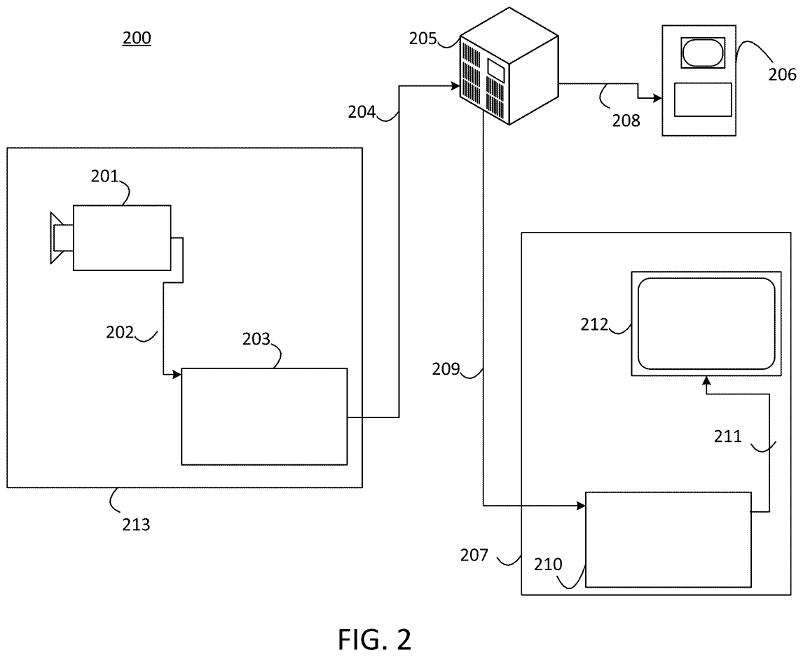

The embodiments of the present disclosure are directed to methods to recover the original connectivity and attributes after regularization. These methods may be applied individually or by any form of combinations. With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

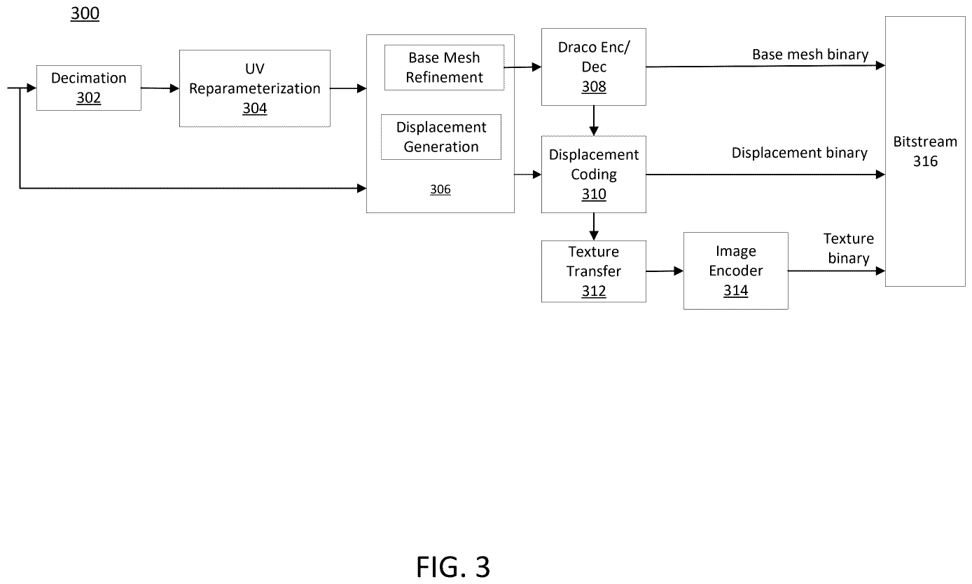

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called “UV Mapping”. The UVs define a 2D position in texture space for each vertex in the mesh.

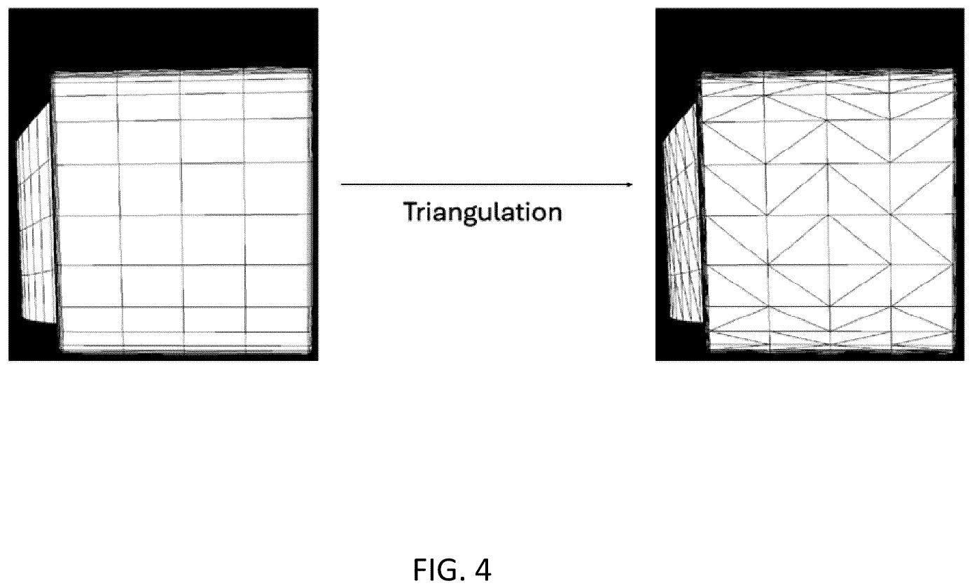

FIG. 4 illustrates an example of triangulation of a mesh. In one or more examples, the triangulation process splits quads into pairs of triangles, often resulting in irregular connectivity with vertex degrees ranging from 4 to 8, as shown in FIG. 4.

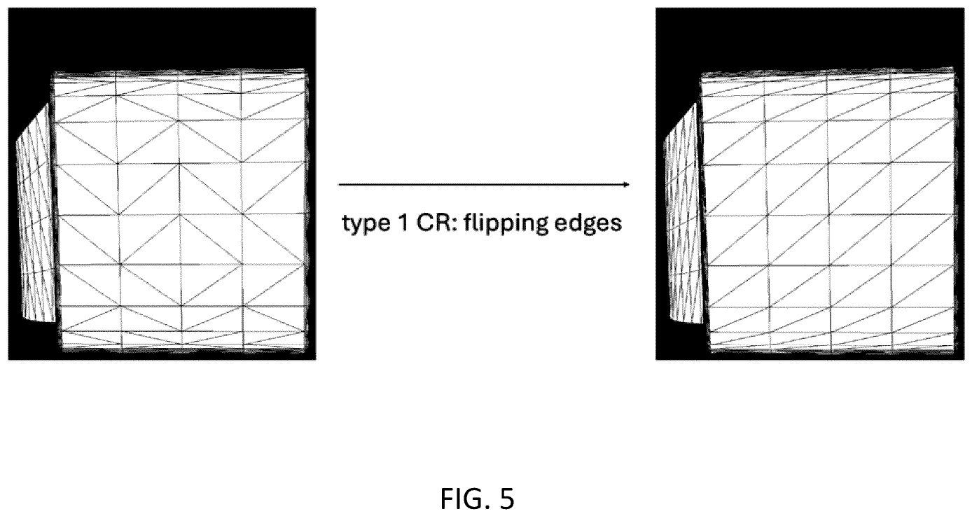

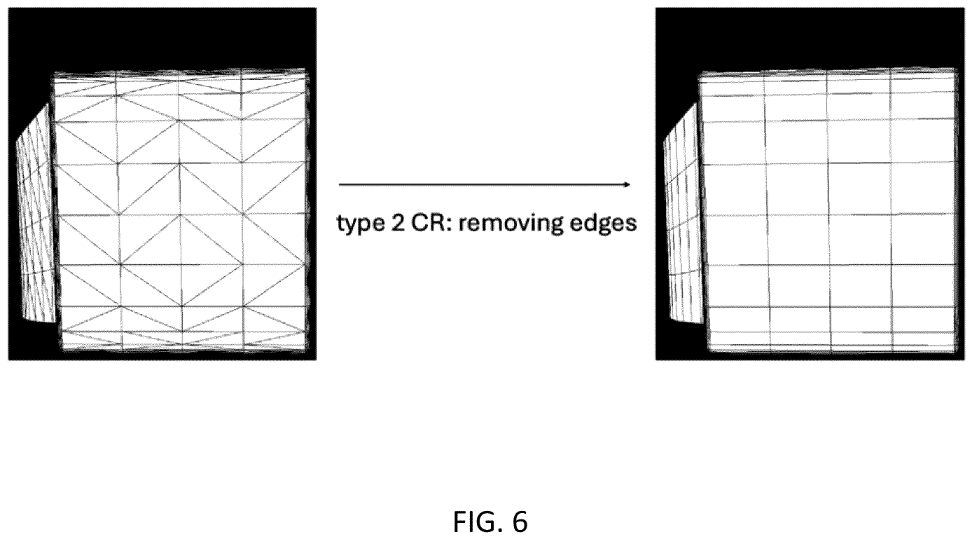

According to an embodiments of the present disclosure, there may be at least to types of connectivity regularization (CR): Type 1 and Type 2. In one or more examples, Type 1 CR flips edges aiming to achieve a vertex degree of 6, as illustrated in FIG. 5. In one or more examples, Type 2 CR removes edges aiming to recover an original quad mesh and achieve a vertex degree of 4, as illustrated in FIG. 6.

An method to recover connectivity after type 1 CR by flipping back edges that were flipped during regularization may be performed. The following method illustrates how to restore geometry connectivity after Type 2 CR.

```
Restore geometry connectivity after type 2 CR:
hasQuad = false
restoredIndices.resize(restoredIndexCount)
restoredFacesStartIndices.resize(restoredFaceCount + 1)
restoredFacesStartIndices[0] = 0
for (f0 = 0, f1 = 0; f1 < faceCount; + + f1) {
  i0 = restoredFacesStartIndices[f0]
  k0 = facesStartIndices[f1]
  k1 = facesStartIndices[f1 + 1]
  if (removedEdges[f1] < 0) {
    faceDegree = k1 − k0
    hasQuad | = (faceDegree == 4)
    copy(indices.begin( ) + k0,indices.begin( ) + k1,restoredIndices.begin( ) + i0)
    restoredFacesStartIndices[+ + f0] = restoredFacesStartIndices[f0] +
faceDegree
    continue
  }
  if (removedEdges[f1] > 0) {
    restoredIndices[i0 + 0] = indices[k0 + 0]
    restoredIndices[i0 + 1] = indices[k0 + 1]
    restoredIndices[i0 + 2] = indices[k0 + 2]
    restoredIndices[i0 + 3] = indices[k0 + 0]
    restoredIndices[i0 + 4] = indices[k0 + 2]
    restoredIndices[i0 + 5] = indices[k0 + 3]
  } else {
    restoredIndices[i0 + 0] = indices[k0 + 0]
    restoredIndices[i0 + 1] = indices[k0 + 1]
    restoredIndices[i0 + 2] = indices[k0 + 3]
    restoredIndices[i0 + 3] = indices[k0 + 1]
    restoredIndices[i0 + 4] = indices[k0 + 2]
    restoredIndices[i0 + 5] = indices[k0 + 3]
  }
    restoredFacesStartIndices[+ + f0] = restoredFacesStartIndices[f0] + 3
    restoredFacesStartIndices[+ + f0] = restoredFacesStartIndices[f0] + 3
}
if (faceType ! = polygonal) {
  faceType = hasQuad ? triangular_quadrilateral : triangular
}
```

The parameter indices may store face vertex indices of the regularized mesh, and the parameter facesStartIndices may store the starting index of each face in indices. The parameter removedEdges[f1]<0 may indicate the face with index f1 in the regularized mesh is an original face that is not generated by CR, and removedEdges[f1]=0 or 1 may mean the face with index f1 was generated by Type 2 CR and represent the two possible directions of the removed diagonal edge of the face.

A corner attribute may be one or more attributes for a vertex shared by a multiple faces. For example, a vertex may be shared by four faces, where at least two faces may have different corner attributes. A method of performing of recovering connectivity of a corner attribute may be described as follows:

```
Restore connectivity of a corner attribute after type 2 CR:
restoredAttrIndices.resize(restoredIndexCount)
for (f0 = 0, f1 = 0; f1 < faceCount; + + f1) {
  i0 = restoredFacesStartIndices[f0]
  k0 = facesStartIndices[f1]
  k1= facesStartIndices[f1 + 1]
  if (removedEdges[f1] < 0) {
    copy(attrIndices.begin( ) + k0, attrIndices.begin( ) +
k1,restoredAttrIndices.begin( ) + i0)
    + + f0
    continue
  }
  if (removedEdges[f1] > 0) {
    restoredAttrIndices[i0 + 0] = attrIndices[k0 + 0]
    restoredAttrIndices[i0 + 1] = attrIndices[k0 + 1]
    restoredAttrIndices[i0 + 2] = attrIndices[k0 + 2]
    restoredAttrIndices[i0 + 3] = attrIndices[k0 + 0]
    restoredAttrIndices[i0 + 4] = attrIndices[k0 + 2]
    restoredAttrIndices[i0 + 5] = attrIndices[k0 + 3]
  } else {
    restoredAttrIndices[i0 + 0] = attrIndices[k0 + 0]
    restoredAttrIndices[i0 + 1] = attrIndices[k0 + 1]
    restoredAttrIndices[i0 + 2] = attrIndices[k0 + 3]
    restoredAttrIndices[i0 + 3] = attrIndices[k0 + 1]
    restoredAttrIndices[i0 + 4] = attrIndices[k0 + 2]
    restoredAttrIndices[i0 + 5] = attrIndices[k0 + 3]
  }
  f0 = f0 + 2
}
```

The following method shows how to restore the face attribute indices or values after type 2 CR:

```
Restore face attribute indices or values after type 2 CR:
restoredAttr.resize(restoredCount)
for (f0 = 0, f1 = 0; f1 < faceCount; + + f1) {
  restoredAttr[f0 + +] = attr[f1]
  if (removedEdges[f1] ≥ 0) {
    restoredAttr[f0 + +] = attr[f1]
  }
}
```

If face attribute indices (resp. values) are restored, then restoredAttr stores the restored face attribute indices (resp. values) and attr stores the regularized face attribute indices (resp. values).

After Type 1 CR and recover the geometry connectivity, the locations of the two triangles related to an edge flipping may be swapped with respect to their locations in the original mesh. Therefore, if there is a face attribute, locations of the two triangles may be swapped, or their face attribute values may be swapped, as illustrated below:

```
Swap locations of triangle pairs of edge flipping:
for (triIdx1, triIdx2 : edgeFlippingTrianglePairs) {
  faceStartIdx1 = facesStartIndices[triIdx1]
  faceStartIdx2 = facesStartIndices[triIdx2]
  for (i = 0; i < 3; + + i) {
    swap(indices[faceStartIdx1 + i],indices[faceStartIdx2 + i])
  }
}
Swap face attribute values of triangle pairs of edge flipping:
for (triIdx1, triIdx2 : edgeFlippingTrianglePairs) {
  swap(faceAttrValues[triIdx1],faceAttrValues[triIdx2])
}
```

In one or more examples, a CR method may be adaptively selected. The disclosed CR method may apply to all mesh categories, and the average coding gains range from −0.01% to −0.83%.

Many triangle meshes are obtained by triangulating quad-dominated meshes, and the triangulation process often introduces irregular connectivity with un-uniform vertex degrees, as shown in FIG. 4.

To achieve more uniform vertex degree and thus higher coding efficiency, the current PMC TM v9.0 regularizes connectivity by flipping edges (e.g., Type 1 CR) aiming to achieve vertex degree of six, as shown in FIG. 5. Another CR that removes edges (e.g., Type 2 CR) aiming to recover the original quad-dominated mesh and achieve vertex degree of four, as shown in FIG. 6.

If Type 2 CR is successfully applied, most of the quad faces will be recovered, which allows use of several coding tools that are enabled or available for quad-dominated meshes only, such as dual-degree geometry coding, within-parallelogram predictions, quad-tromino predictions, etc.

In one or more examples, Type 2 CR may be performed using a same flood-fill algorithm as Type 1 CR. The only difference is that, for each detected quad, Type 1 CR records whether the diagonal edge needs to be flipped or not, while Type 2 CR records the direction of the removed diagonal edge.

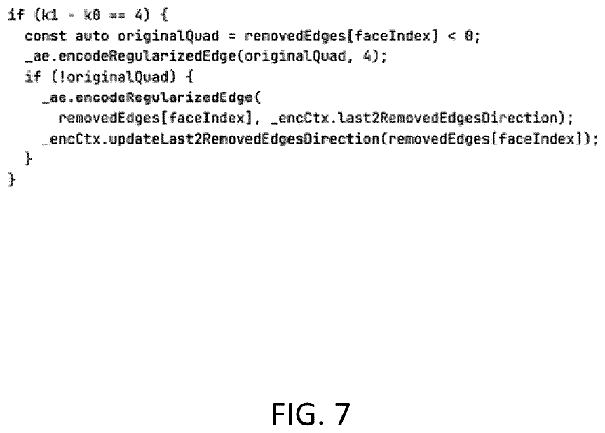

FIG. 7 illustrates an example process of signaling a direction of removed diagonal edges for polygon-fan geometry coding.

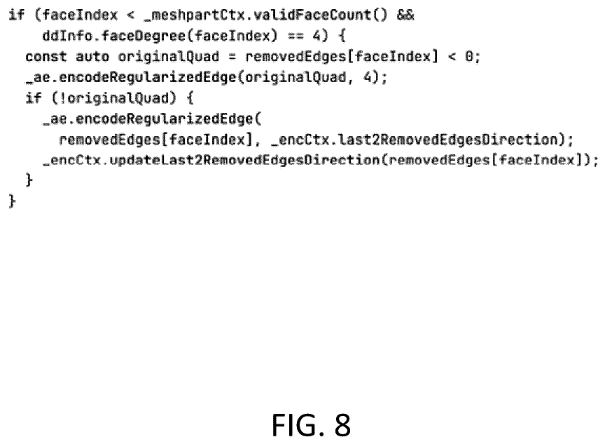

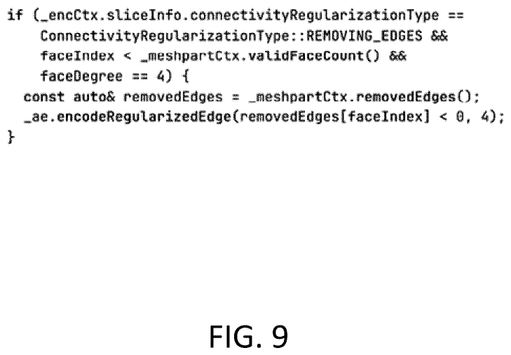

FIG. 8 illustrates an example process of signaling directions of removed diagonal edges for non-initial faces of CCs in dual-degree geometry coding. The difference between the codes in FIGS. 7 and 8 is that, in dual-degree coding, it needs to be checked if a quad face is a dummy face or not, and the direction of the removed diagonal edge for a dummy face does not need to be signaled, while no dummy faces exist in polygon-fan coding. In dual-degree coding, if the initial face of a CC is a non-dummy quad face, information indication whether the initial face is a regularized quad face or an original quad face is signaled. If the initial face is a regularized quad face, the direction of a removed diagonal edge does not need to be signaled because the vertex indices of the initial face of a CC are never rotated by the encoder. Thus the decoder knows the direction of the removed diagonal edge without signaling, as illustrated in FIG. 9.

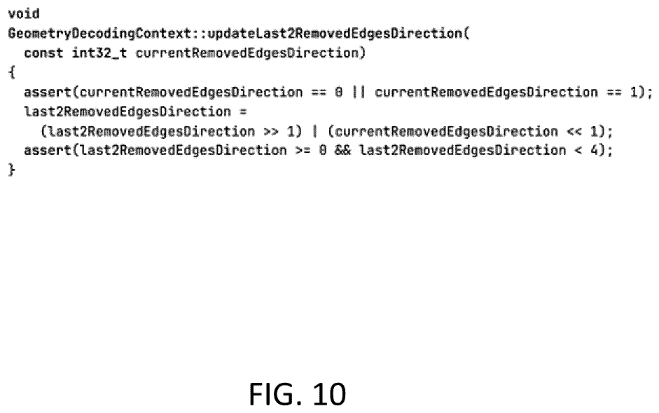

In one or more examples, the contexts of coding flipped edges may be reused for coding removed diagonal edges and no new contexts are added. And the context of coding a removed diagonal edges is chosen based on the directions of the last two removed diagonal edges, as shown in FIG. 10.

An example of method to adaptively enable/disable CR and select the type of CR may be performed as follows:
1. First, type 2 CR is tried to regularize the connectivity. If it succeeds (satisfying all three criteria below), then type 2 CR is selected.
2. If type 2 CR in step 1 fails, then type 1 CR is tried to regularize the connectivity. If it succeeds (satisfying criteria 1 and 2 below), then type 1 CR is selected.
3. If type 1 CR in step 2 fails as well, then CR is disabled, and the mesh is coded without regularization.

Three criteria used to enable CR may be as follows:
Criterion 1: at least 90% triangles faces in the original mesh are in the quads detected by the CR process.
Criterion 2: no more than 1% of diagonal edges of detected quads are seam edges.
Criterion 3: at least 95% of regularized quads are rectangles, where a regularized quad is a quad generated by type 2 CR.

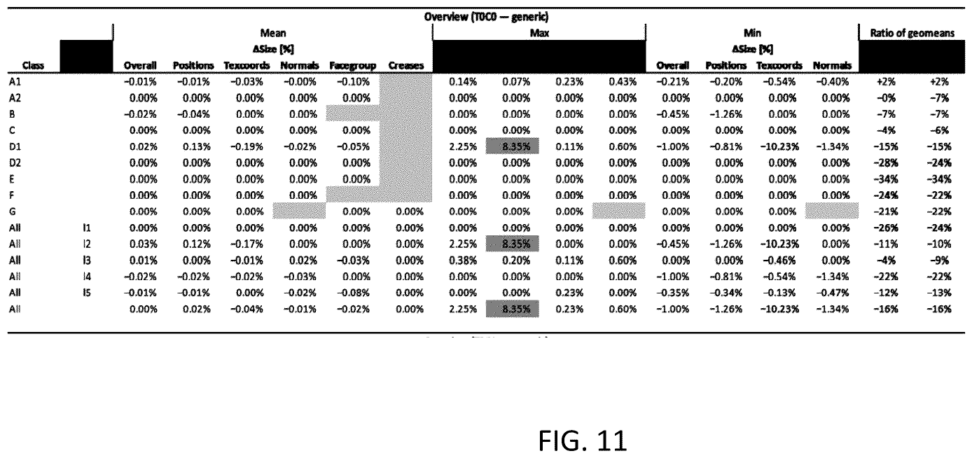

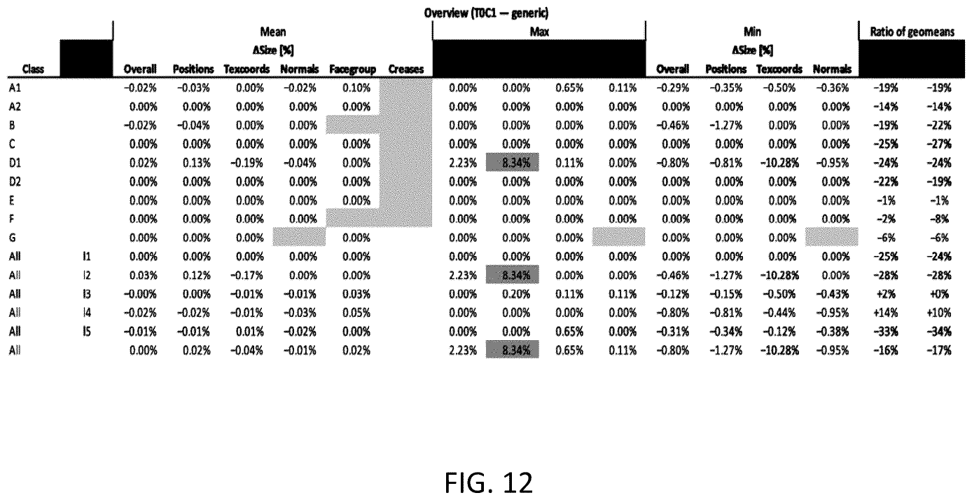

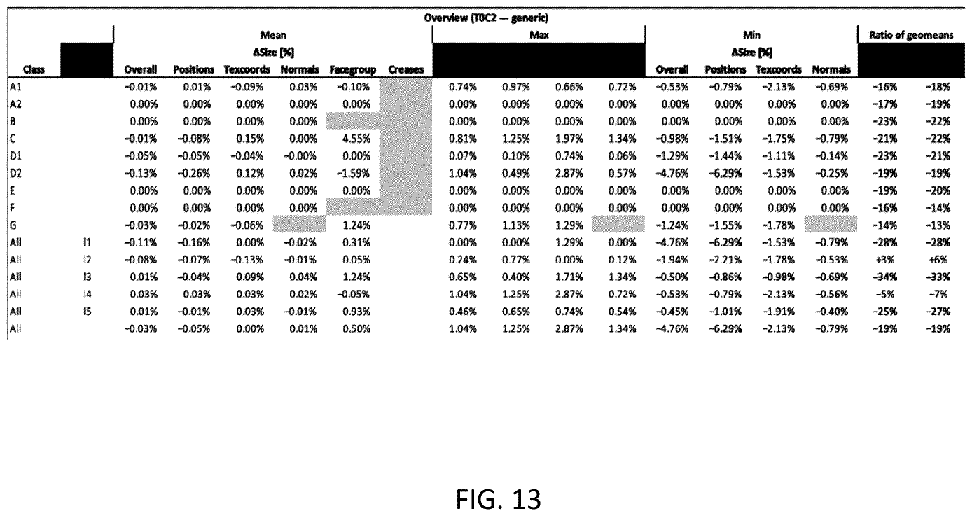

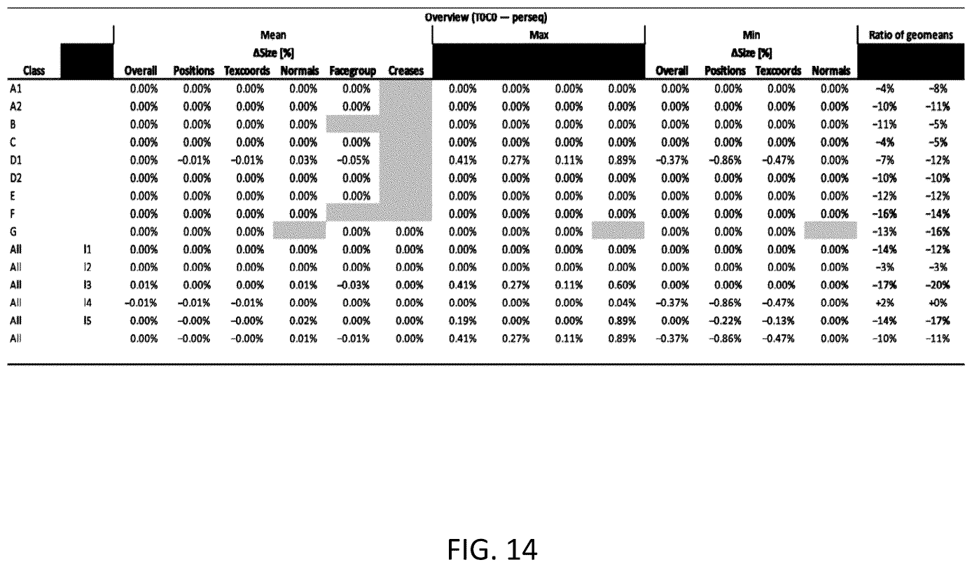

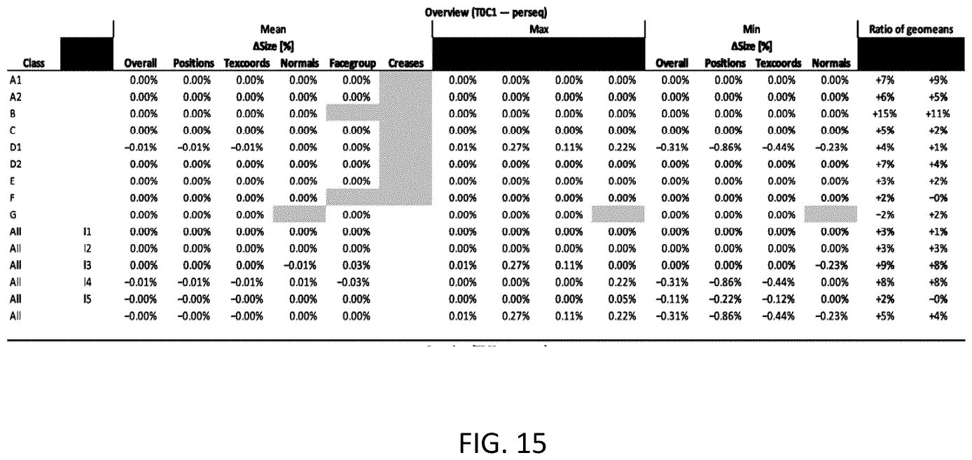

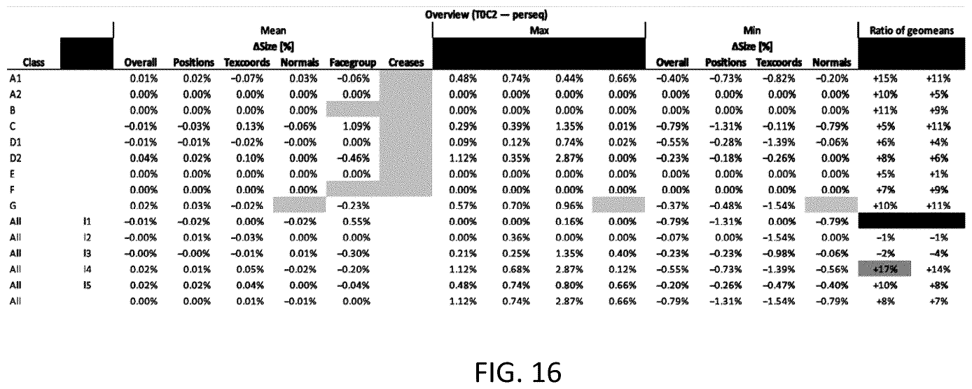

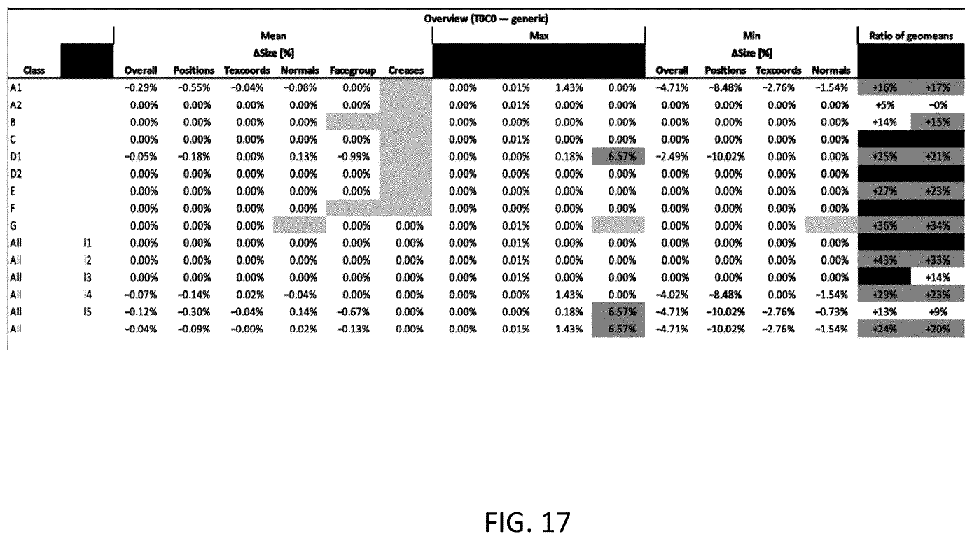

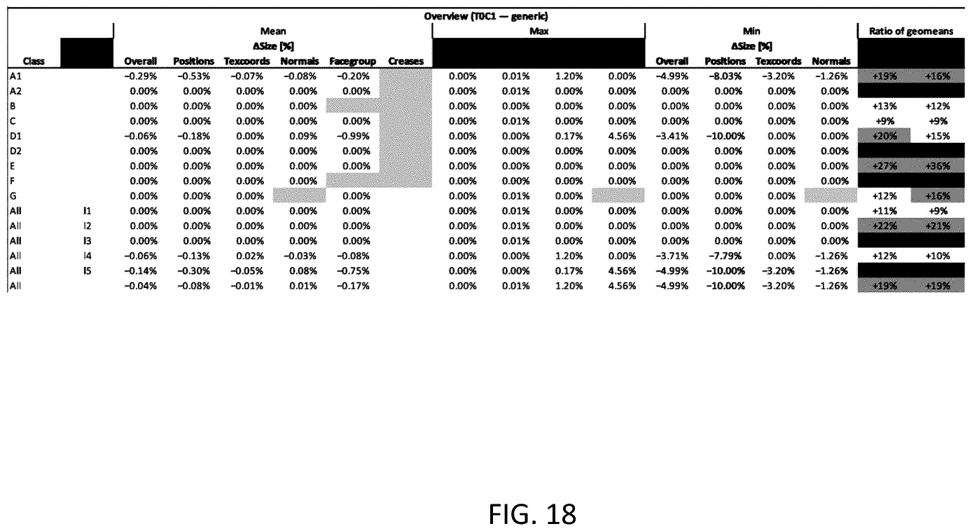

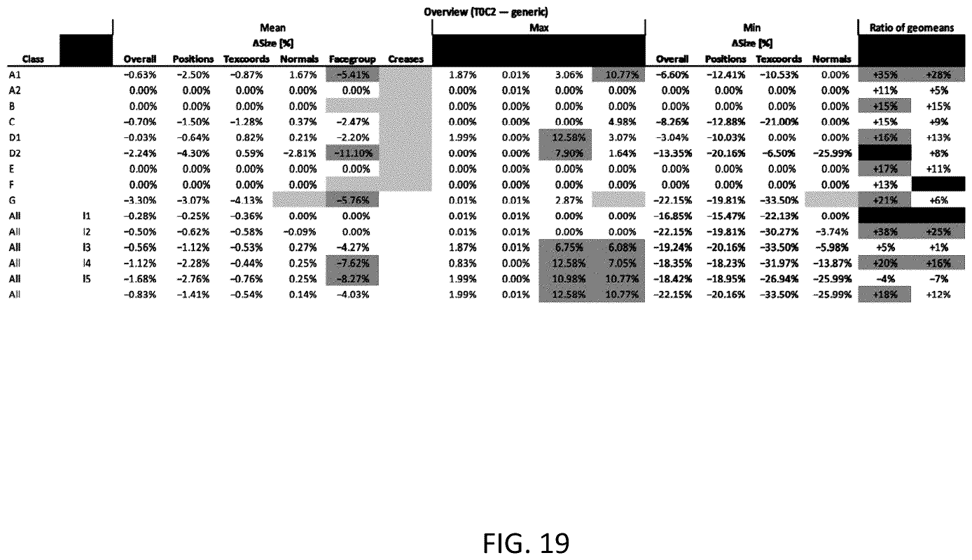

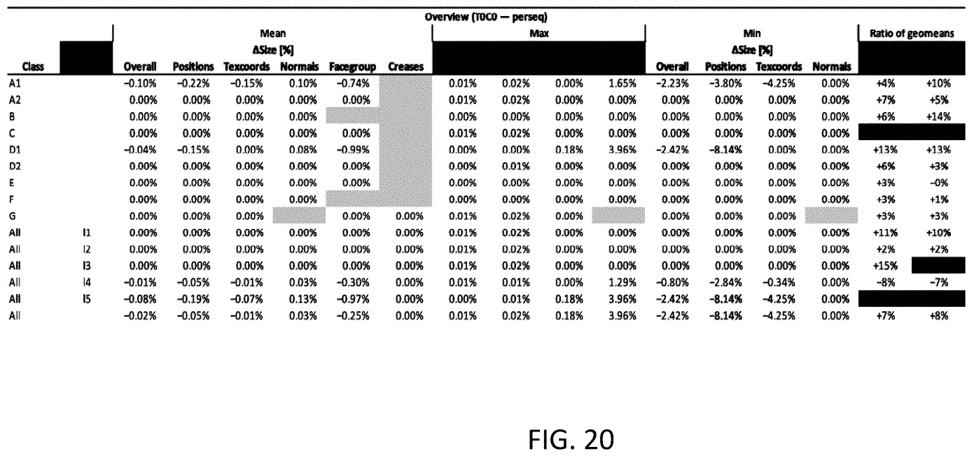

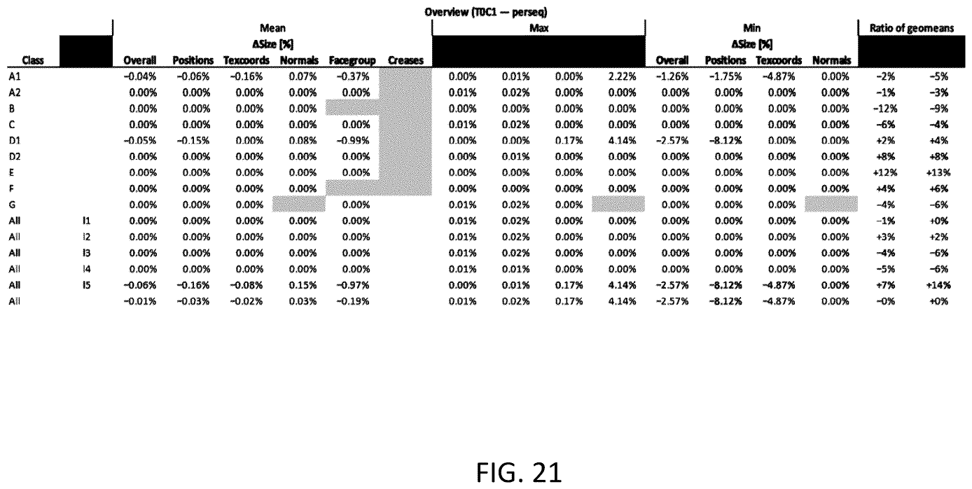

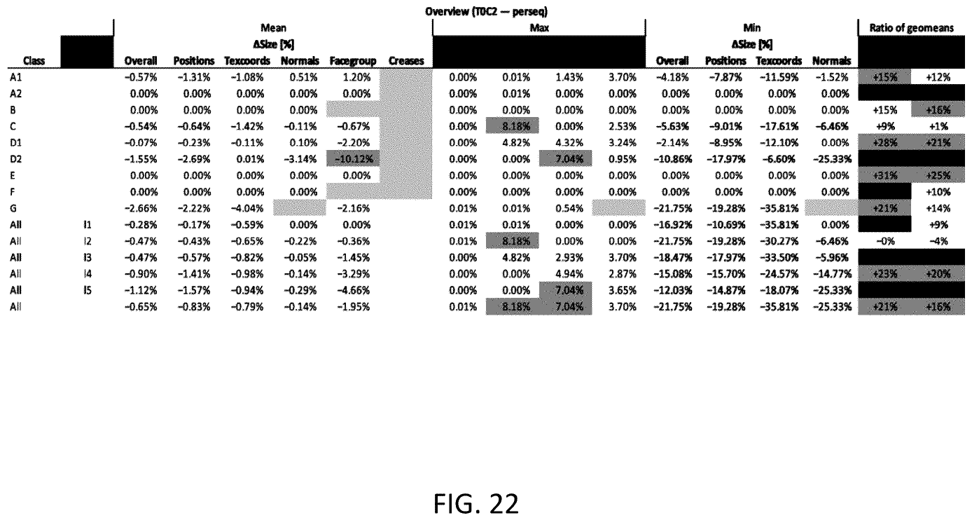

FIGS. 11-13 illustrate lossless results of fixed Type 1 connectivity regularization vs. TM v9.0 with default configurations (cfgs). FIGS. 14-16 illustrate lossless results of fixed Type 1 CR vs. TM v9.0 with per mesh cfgs. FIGS. 17-19 illustrate lossless results of Type 2 CR vs fixed Type 1 CR with default cfgs. FIGS. 20-22 illustrate lossless results of type 2 CR vs. fixed Type 1 CR with per mesh cfgs.

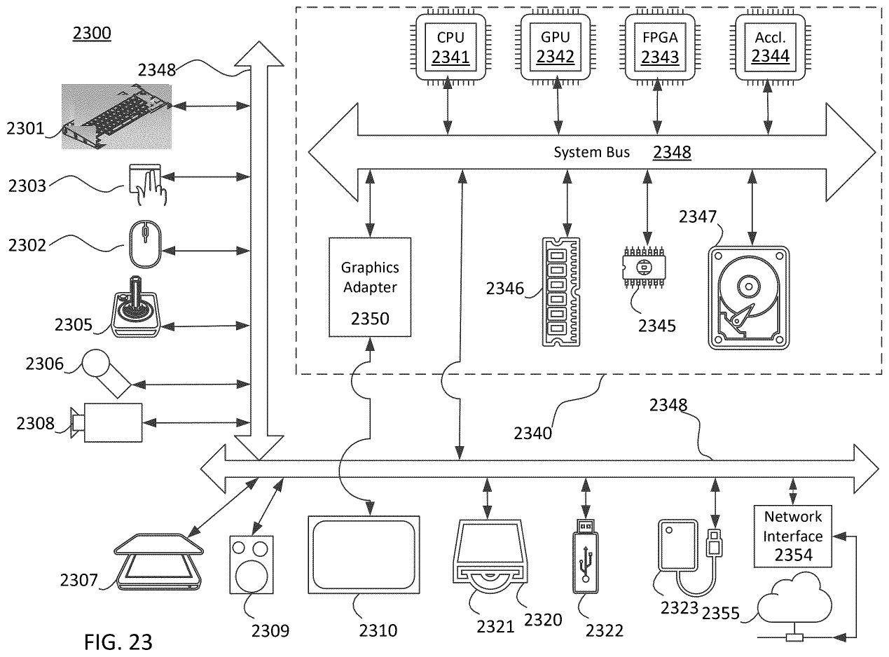

The techniques, described above, may be implemented as computer software using computer-readable instructions and physically stored in one or more computer-readable media. For example, FIG. 23 shows a computer system 2300 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 23 for computer system 2300 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 2300.

Computer system 2300 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 2301, mouse 2302, trackpad 2303, touch screen 2310, data-glove, joystick 2305, microphone 2306, scanner 2307, camera 2308.

Computer system 2300 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 2310, data glove, or joystick 2305, but there may also be tactile feedback devices that do not serve as input devices). For example, such devices may be audio output devices (such as: speakers 2309, headphones (not depicted)), visual output devices (such as screens 2310 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 2300 may also include human accessible storage devices and their associated media such as optical media including CD/DVD ROM/RW 2320 with CD/DVD or the like media 2321, thumb-drive 2322, removable hard drive or solid state drive 2323, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 2300 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 2349 (such as, for example USB ports of the computer system 2300; others are commonly integrated into the core of the computer system 2300 by attachment to a system bus as described below (for example Ethernet interface into a PC computer system or cellular network interface into a smartphone computer system). Using any of these networks, computer system 2300 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 2355. Certain protocols and protocol stacks may be used on each of those networks and network interfaces as described above.

Aforementioned human interface devices, human-accessible storage devices, and network interfaces 2354 may be attached to a core 2340 of the computer system 2300.

The core 2340 may include one or more Central Processing Units (CPU) 2341, Graphics Processing Units (GPU) 2342, specialized programmable processing units in the form of Field Programmable Gate Areas (FPGA) 2343, hardware accelerators for certain tasks 2344, and so forth. These devices, along with Read-only memory (ROM) 2345, Random-access memory 2346, internal mass storage such as internal non-user accessible hard drives, SSDs, and the like 2347, may be connected through a system bus 2348. In some computer systems, the system bus 2348 may be accessible in the form of one or more physical plugs to enable extensions by additional CPUs, GPU, and the like. The peripheral devices may be attached either directly to the core's system bus 2348, or through a peripheral bus 2349. Architectures for a peripheral bus include PCI, USB, and the like. A graphics adapter 2350 may be included in the core 2340.

CPUs 2341, GPUs 2342, FPGAs 2343, and accelerators 2344 may execute certain instructions that, in combination, may make up the aforementioned computer code. That computer code may be stored in ROM 2345 or RAM 2346. Transitional data may be also be stored in RAM 2346, whereas permanent data may be stored for example, in the internal mass storage 2347. Fast storage and retrieve to any of the memory devices may be enabled through the use of cache memory, that may be closely associated with one or more CPU 2341, GPU 2342, mass storage 2347, ROM 2345, RAM 2346, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 2300, and specifically the core 2340 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 2340 that are of non-transitory nature, such as core-internal mass storage 2347 or ROM 2345. The software implementing various embodiments of the present disclosure may be stored in such devices and executed by core 2340. A computer-readable medium may include one or more memory devices or chips, according to particular needs. The software may cause the core 2340 and specifically the processors therein (including CPU, GPU, FPGA, and the like) to execute particular processes or particular parts of particular processes described herein, including defining data structures stored in RAM 2346 and modifying such data structures according to the processes defined by the software. In addition or as an alternative, the computer system may provide functionality as a result of logic hardwired or otherwise embodied in a circuit (for example: accelerator 2344), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method performed by at least one processor in a decoder including: receiving a bitstream comprising an encoded mesh, a first parameter indicating a connectivity regularization (CR) type, and a second parameter associated with restoration of an edge of at least one face in the encoded mesh; determining the first parameter indicates the CR type removes edges from the mesh; and reconstructing the at least one face of the encoded mesh using the second parameter.
(2) The method according to feature (1), in which the first parameter is a first value indicating no CR is applied to the mesh, a second value that indicates a first type of CR in which an edge is flipped, and a second value indicating a second CR type that removes edges from the second parameter.
(3) The method according to feature (1) or (2), in which the second parameter is a value that indicates that the at least one face is an original face in which an edge does not need to be added to the face.
(4) The method according to any one of features (1)-(3), in which the second parameter is a value the indicates a direction of an edge to be added to the at least one face.
(5) The method according to any one of features (1)-(4), in which the at least one face is a quad face, and an edge to be added to the quad face is a diagonal edge.
(6) The method according to any one of features (1)-(5), in which the bitstream further comprises a corner attribute of a vertex of the at least one face is shared with a vertex of another face, in which the corner attribute includes a first value for the vertex of the at least one face and a second value different from the first value for the vertex of another face, in which the method further comprises reconstructing the at least one face in accordance with the corner attribute.
(7) The method according to any one of features (1)-(6), in which the bitstream further comprises a face attribute when the first parameter indicates the CR type removes edges from the mesh, in which the method further comprises reconstructing the at least one face in accordance with the face attribute.
(8) A method performed by at least one encoder including receiving a mesh comprising a plurality of vertices; encoding the mesh in accordance with a connectivity regularization (CR) type that removes edges from the mesh; encoding a first parameter indicating the CR type; encoding a second parameter associated with restoration of an edge of at least one face in the mesh; generating a bitstream comprising the mesh, the first parameter, and the second parameter.
(9) The method according to feature (8), in which the first parameter is a first value indicating no CR is applied to the mesh, a second value that indicates a first type of CR in which an edge is flipped, and a second value indicating a second CR type that removes edges from the second parameter.
(10) The method according to feature (8) or (9), in which the second parameter is a value that indicates that the at least one face is an original face in which an edge does not need to be added to the face.
(11) The method according to any one of features (8)-(10), in which the second parameter is a value the indicates a direction of an edge to be added to the at least one face.
(12) The method according to any one of features (8)-(11), in which the at least one face is a quad face, and an edge to be added to the quad face is a diagonal edge.
(13) The method according to any one of features (8)-(12), further including encoding a corner attribute of a vertex of the at least one face that is shared with a vertex of another face, in which the corner attribute includes a first value for the vertex of the at least one face and a second value different from the first value for the vertex of another face, in which the bitstream further comprises the corner attribute.
(14) The method according to any one of features (8)-(13), further including encoding a face attribute when the first parameter indicates the CR type removes edges from the mesh, in which the bitstream further comprises the face attribute.
(15) A non-transitory computer readable medium storing a bitstream that is generated by an encoding method including receiving a mesh comprising a plurality of vertices; encoding the mesh in accordance with a connectivity regularization (CR) type that removes edges from the mesh; encoding a first parameter indicating the CR type; encoding a second parameter associated with restoration of an edge of at least one face in the mesh; generating the bitstream comprising the mesh, the first parameter, and the second parameter.
(16) The method according to feature (15), in which the first parameter is a first value indicating no CR is applied to the mesh, a second value that indicates a first type of CR in which an edge is flipped, and a second value indicating a second CR type that removes edges from the second parameter.
(17) The method according to feature (15) or (16), in which the second parameter is a value that indicates that the at least one face is an original face in which an edge does not need to be added to the face.
(18) The method according to any one of features (15)-(17), in which the second parameter is a value the indicates a direction of an edge to be added to the at least one face.
(19) The method according to any one of features (15)-(18), in which the at least one face is a quad face, and an edge to be added to the quad face is a diagonal edge.
(20) The method according to any one of features (15)-(19), further including encoding a corner attribute of a vertex of the at least one face that is shared with a vertex of another face, in which the corner attribute includes a first value for the vertex of the at least one face and a second value different from the first value for the vertex of another face, in which the bitstream further comprises the corner attribute.

What is claimed is:

1. A method performed by at least one processor in a decoder, the method comprising:
receiving a bitstream comprising an encoded mesh, a first parameter indicating a connectivity regularization (CR) type, and a second parameter associated with restoration of an edge of at least one face in the encoded mesh;
determining the first parameter indicates the CR type removes edges from the mesh; and
reconstructing the at least one face of the encoded mesh using the second parameter.

2. The method according to claim 1, wherein the first parameter is a first value indicating no CR is applied to the mesh, a second value that indicates a first type of CR in which an edge is flipped, and a second value indicating a second CR type that removes edges from the second parameter.

3. The method according to claim 1, wherein the second parameter is a value that indicates that the at least one face is an original face in which an edge does not need to be added to the face.

4. The method according to claim 1, wherein the second parameter is a value the indicates a direction of an edge to be added to the at least one face.

5. The method according to claim 1, wherein the at least one face is a quad face, and an edge to be added to the quad face is a diagonal edge.

6. The method according to claim 1, wherein the bitstream further comprises a corner attribute of a vertex of the at least one face is shared with a vertex of another face,
wherein the corner attribute includes a first value for the vertex of the at least one face and a second value different from the first value for the vertex of another face,
wherein the method further comprises reconstructing the at least one face in accordance with the corner attribute.

7. The method according to claim 1, wherein the bitstream further comprises a face attribute when the first parameter indicates the CR type removes edges from the mesh,
wherein the method further comprises reconstructing the at least one face in accordance with the face attribute.

8. A method performed by at least one encoder, the method comprising;
receiving a mesh comprising a plurality of vertices;
encoding the mesh in accordance with a connectivity regularization (CR) type that removes edges from the mesh;
encoding a first parameter indicating the CR type;
encoding a second parameter associated with restoration of an edge of at least one face in the mesh; and
generating a bitstream comprising the mesh, the first parameter, and the second parameter.

9. The method according to claim 8, wherein the first parameter is a first value indicating no CR is applied to the mesh, a second value that indicates a first type of CR in which an edge is flipped, and a second value indicating a second CR type that removes edges from the second parameter.

10. The method according to claim 8, wherein the second parameter is a value that indicates that the at least one face is an original face in which an edge does not need to be added to the face.

11. The method according to claim 8, wherein the second parameter is a value the indicates a direction of an edge to be added to the at least one face.

12. The method according to claim 8, wherein the at least one face is a quad face, and an edge to be added to the quad face is a diagonal edge.

13. The method according to claim 8, further comprising
encoding a corner attribute of a vertex of the at least one face that is shared with a vertex of another face,
wherein the corner attribute includes a first value for the vertex of the at least one face and a second value different from the first value for the vertex of another face,
wherein the bitstream further comprises the corner attribute.

14. The method according to claim 8, further comprises:
encoding a face attribute when the first parameter indicates the CR type removes edges from the mesh,
wherein the bitstream further comprises the face attribute.

15. A non-transitory computer readable medium storing a bitstream that is generated by an encoding method, the encoding method comprising:
receiving a mesh comprising a plurality of vertices;
encoding the mesh in accordance with a connectivity regularization (CR) type that removes edges from the mesh;
encoding a first parameter indicating the CR type;
encoding a second parameter associated with restoration of an edge of at least one face in the mesh; and
generating the bitstream comprising the mesh, the first parameter, and the second parameter.

16. The method according to claim 15, wherein the first parameter is a first value indicating no CR is applied to the mesh, a second value that indicates a first type of CR in which an edge is flipped, and a second value indicating a second CR type that removes edges from the second parameter.

17. The method according to claim 15, wherein the second parameter is a value that indicates that the at least one face is an original face in which an edge does not need to be added to the face.

18. The method according to claim 15, wherein the second parameter is a value the indicates a direction of an edge to be added to the at least one face.

19. The method according to claim 15, wherein the at least one face is a quad face, and an edge to be added to the quad face is a diagonal edge.

20. The method according to claim 15, further comprising
encoding a corner attribute of a vertex of the at least one face that is shared with a vertex of another face,
wherein the corner attribute includes a first value for the vertex of the at least one face and a second value different from the first value for the vertex of another face,
wherein the bitstream further comprises the corner attribute.
